(19) United States
(12) Patent Application Publication
(10) Pub. No.: US 2004/0108705 A1
(43) Pub. Date: Jun. 10, 2004

(54) Composite reinforced chassis

(75) Inventor: David E. Witucki, Bay City, MI (US)

Correspondence Address: Robert L. Stearns, Esq., Reising, Ethington, Barnes,, Kisselle, Learman & McCulloch, P.C., 5291 Colony Drive North, Saginaw, MI, 48603, US

(73) Assignee: DELPHI TECHNOLOGIES INC.

(21) Appl. No.: 10/314,786

(22) Filed: Dec. 9, 2002

(51) Int. Cl. B62D 21/00

(52) U.S. Cl. 280/781

(57) ABSTRACT

A vehicle chassis is a shaped metal sheet chassis body or member with regions of relatively low torsional rigidity, and regions of relatively higher torsional rigidity. At least some of the low torsional rigidity regions are reinforced with a composite overlay comprising directionally oriented long fibers of carbon or the like which may be woven into a mat of directionally oriented fibers and embedded in a matrix of resin or the like. The overlay increases the regions of the chassis to which is applied without significantly increasing the weight of the chassis.

### TECHNICAL FIELD

This invention relates generally to constructions and methods for making vehicle chassis, and particularly vehicle frames out of formed metal in a manner to achieve high torsional rigidity of the frames.

### BACKGROUND OF THE INVENTION

It is common in the manufacture of automotive vehicles to form the frame of the vehicle chassis and related components out of steel sheet or plate material, which is stamped or hydro-formed to the desired size and shape for its intended purpose. In use, the formed metal plate chassis is subjected to torsional loads, which tend to twist and flex the chassis. In many vehicle applications, it is desirable to have a chassis frame that is rigid to resist torsional deflection of the frame, but also a frame which is light weight and economically feasible to manufacture on a mass production basis.

However, increasing the torsional rigidity of a chassis frame typically comes a the expense of adding cost and weight to the chassis since in order to increase the torsional rigidity, the present approach is to increase the wall thickness of the metal sheet material from which the frame is made, or to weld additional steel reinforcements or brackets to an existing formed metal sheet frame. The first approach has the additional disadvantage of increasing the forces necessary to shape the material, and thus increasing the cost of tooling, and further results in the over-engineering of those areas of the chassis not in need of re-enforcement. The latter approach requires special fixturing and welding equipment and increases the inventory of component parts.

It is an object of the present invention to simplify the manufacture of vehicle chassis, and particularly the vehicle frame, to increase the torsional rigidity of otherwise convention formed metal sheet chassis without significantly increasing the cost, complexity or weight of the torsional rigidity-enhanced chassis.

### SUMMARY OF THE INVENTION

A vehicle chassis construction according to a presently preferred embodiment of the invention includes a form-shaped metal sheet chassis member having predetermined low torsional rigidity regions with relatively lower torsional rigidity than other regions of the chassis member, and a composite overlay of directionally oriented fibers embedded in a matrix applied to at least some of the load torsional rigidity regions of the chassis member to increase the torsional rigidity of such regions.

The invention also contemplates a method for fabricating vehicle chassis in which a shaped metal sheet chassis member is formed having certain regions with less torsional rigidity than other regions and to which a composite overlay is applied to at least some of those regions in the form of directionally oriented fibers embedded in a resin matrix to thereby increase the torsional rigidity of such regions.

The invention has the advantage of providing a simple but effective means of increasing the torsional rigidity of otherwise conventional metal sheet chassis without significantly increasing the weight or expense of manufacturing vehicle chassis.

The composite overlay in the form of directionally oriented fibers embedded in a matrix has a characteristic high-torsional rigidity and, advantageously, a low weight to hertz ratio, such that a considerable gain in the torsional rigidity of the targeted regions of the metal chassis can be achieved with a comparatively low increase in the overall weight of the chassis, as compared to convention brackets or reinforcement plates of steel that are often added to the low torsional rigidity regions in an effort to increase their rigidity.

Another advantage of the present invention is that the composite overlay can be separately formed or, if desired, formed and shaped in place on the chassis to best suit a particular application of the technology.

The invention has the further advantage of eliminating the need for special welding stations, fixturing, and the like normally associated with the addition of metal reinforcement plates or brackets typically used to increase the rigidity of a conventional chassis frame.

The invention has the further advantage of simplifying the manufacture of the metal sheet component of the chassis, by enabling the manufacturer to design the metal portion with a wall thickness and configuration to meet the design requirements of certain select criteria of a given application, and bringing the balance of the chassis into conformance with torsional rigidity specifications through construction and application of the composite overlays of the invention. As such, the manufacturers of such chassis have significantly increased design flexibility, enabling them to tailor a chassis to the particular requirements of a given application without having to over-engineer the frame, and with a decrease in the overall weight of the chassis as compared to a chassis having the same or similar torsional rigidity characteristics manufactured all in metal.

### BRIEF DESCRIPTION OF THE DRAWINGS

The present invention will now be described, by way of example, with reference to the accompanying drawings, in which:

FIG. 1 is a schematic perspective view of a vehicle chassis prior to reinforcement showing areas of low torsional rigidity;

FIG. 2 shows the chassis of FIG. 1 reinforced according to the present invention;

FIG. 3 is an enlarged perspective view of a chassis member shown reinforced according to the present invention; and

FIG. 4 is a cross-sectional view taken generally along lines 4-4 of FIG. 3.

### DESCRIPTION OF THE PREFERRED EMBODIMENT

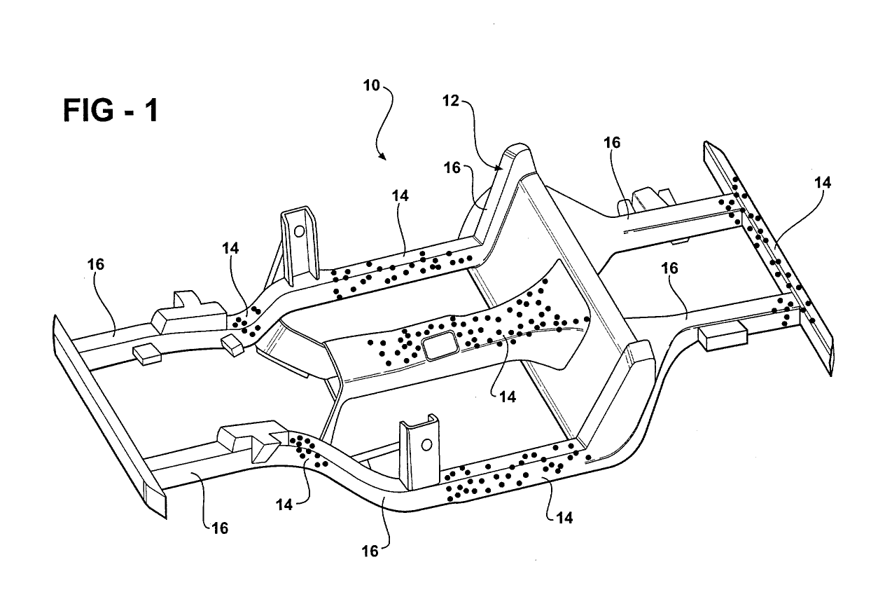

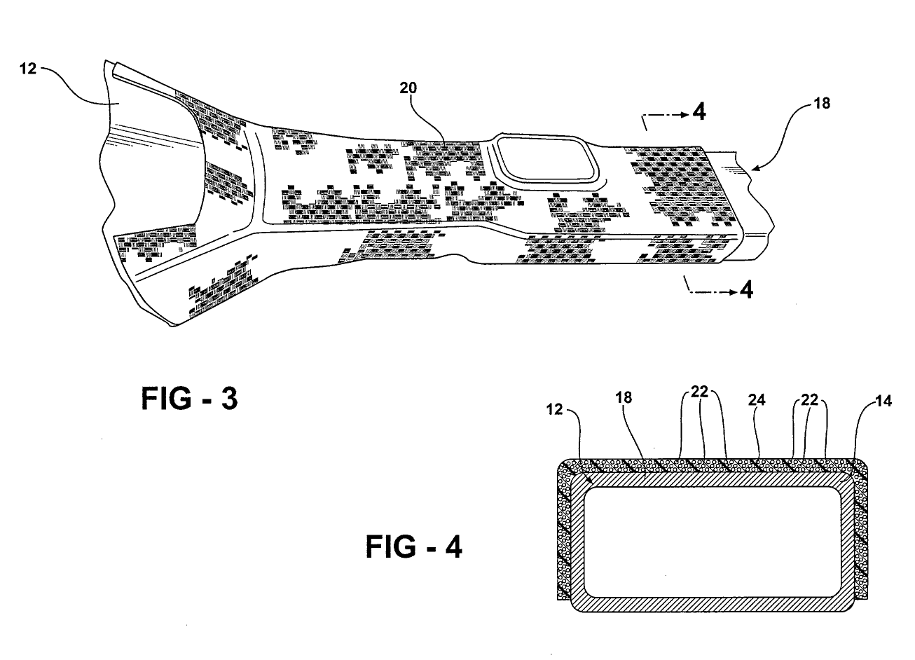

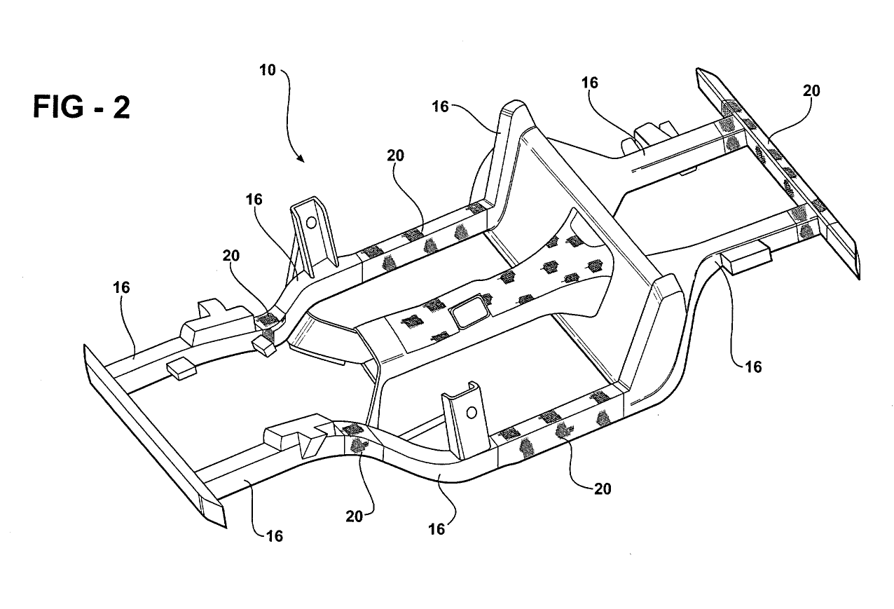

A vehicle chassis constructed according to a presently preferred embodiment of the invention is shown generally at 10 in FIG. 2 and comprises a form-shaped metal plate or sheet chassis member 12 (FIG. 1) having predetermined low-torsional rigidity regions 14 which constitute areas of the chassis member where the torsional rigidity of these regions is determined through analysis to be relatively lower than other higher torsional rigidity regions 16.

The determination of torsional rigidity is representative of how the vehicle chassis 12 will behave when subjected to actual usage or performance qualification conditions when subjected to forces which impart torsional, twisting forces on the chassis 12 that would tend to flex the frame torsionally. The low torsional rigidity regions 14 are, effectively, the weaker regions of the frame that would yield under torsional loads before the other higher torsional rigidity regions 16 and thus are in need of reinforcement according to the invention.

FIG. 3 shows a representative component part 18 of the chassis member 12 representative of a low torsional rigidity region 14 of the chassis 12 which has been reinforced according to the invention. The reinforced chassis component 12 includes a form-shaped metal sheet chassis member or substrate 12 which is fabricated of steel, aluminum-based alloys, or the like and may include any variety of shapes, contours and cross sections, including open and closed channels, flares, openings, and the like. The metallic chassis member 12 has regions of relatively low torsional rigidity 16, represented by the stippled regions of FIG. 1, and regions 18 of relatively higher torsional rigidity represented by the non-stippled regions. When the chassis 10 is subjected to torsional loads in use of the chassis in a vehicle, it is the regions of relatively low torsional rigidity 16 that are prone flexing and deforming elastically under load due to their lower resistance to performing under the torsion load. According to the invention, these load torsional rigidity regions 16 are reinforced to increase their rigidity in order to make those regions 16, and thus the overall chassis 10 more rigid as a unit and able to sustain the same or higher torsional loads without flexing. Further, according to the invention, this increase in rigidity is achieved with minimal increase in weight of the chassis 10.

The representative low torsional rigidity component 12 of FIG. 3 is shown reinforced with a composite overlay 20 of directionally oriented fibers 22 which are embedded in a matrix, preferably a resin matrix, 24 and applied to at least some and preferably all of the low torsional rigidity regions 16 of the metal chassis member 12 in order to increase the torsional rigidity of such regions 16. It will be appreciated that the use of the overlay 20 enables a manufacturer of chassis to engineer the chassis to have a specific torsional rigidity profile in order to tune the chassis to attain the desired and optimum torsional rigidity profile for a given application. For example, the low torsional rigidity region 16 can be reinforced with the composite overlay 20 to increase the rigidity to the level of the regions of high torsional rigidity 18 or, if desired, above or below the high torsional rigidity regions 18 as best suited for a given application.

It will be further appreciated that the composite overlay 20 can be applied to one or more of the high torsional rigidity regions 18 to increase the rigidity of these regions as well, if called for by a given application. In this way, the manufacturer of chassis is able to produce the metal sheet chassis member substrate 14 with thinner gage walls or smaller dimensions, at least in the regions of low torsional rigidity 16 than would otherwise be required in order to provide the chassis 10 with the acceptable level of torsional rigidity in such lowest torsional rigidity regions 16. With the advent of the composite overlay 20, these otherwise unacceptably low regions of torsional rigidity 16 can be reinforced to acceptable regions with far less weight and restrictions on geometry.

As best illustrated in FIG. 3, the composite overlay 20 can be applied to one or both surfaces of the chassis member 12. It will be further seen that the fibers 22 are aligned with adjacent fibers in a single direction and the fibers 22 are preferably long, exceeding several inches, and more preferably extend the majority of the length of a given reinforced region. The fibers 22 are preferably supplied as a woven mat of long fibers which are directionally oriented in groups and woven into a given pattern, such as the checkerboard pattern illustrated in FIG. 3, in which groupings of the fibers are oriented 90 degrees relative to one another. Such directional orientation of the fibers is to be contrasted to other types of fiber reinforced composites including chopped fiber mat composites in which the fibers are short (less than 1 inch) and randomly dispersed so that there is no directional orientation of the fibers as in the present overlay 20. The fiber preferably comprises carbon fibers, although boron and other fibers are contemplated by the invention. The resin matrix may comprise any suitable matrix material appropriate for a given application, such as epoxies, and the like. The directional orientation of the fibers 22 and their length reinforced by the matrix 24 gives the overlay 20 considerable rigidity far exceeding that of the middle chassis member 12 and, when applied to the chassis member 12 increases the combined torsional rigidity with little added weight. The rate of improvement in torsional rigidity with the addition of the composite overlay 20 is less than 10 kg/Hz and preferably on the order of about 4.5 kg/Hz. By comparison, an increase in torsional rigidity with welded steel reinforcement overlay plates is at a rate greater than 10 kg/Hz.

The overlay 20 can be prefabricated to the appropriate size and shape separately from the chassis member 12 and thereafter bonded to the chassis member, or may be formed in place on the chassis member.

Accordingly, it will be appreciated that the reinforced chassis 10 provides great flexibility for a manufacturer to custom tune a chassis to provide the desired torsional rigidity at select regions without adding considerable weight to the weight to the chassis.

Obviously, many modifications and variations of the present invention are possible in light of the above teachings. It is, therefore, to be understood that within the scope of the appended claims, the invention may be practiced otherwise than as specifically described. The invention is defined by the claims.

1. A vehicle chassis construction, comprising:
a form-shaped metal sheet chassis member having predetermined low torsional rigidity regions with relatively lower torsional rigidity than other regions of said metal sheet chassis member; and
a composite overlay of directionally oriented fibers embedded in a matrix applied to at least some of said low torsional rigidity regions of said metal sheet chassis member to increase the torsional rigidity of such regions.

2. The construction of claim 1 wherein said increase in said torsional rigidity is at a rate of less than 10 kg/Hz.

3. The construction of claim 2 wherein the increase in torsional rigidity is at a rate of about 4.5 kg/Hz.

4. The construction of claim 1 wherein said overlay comprises a plurality of oriented carbon fibers in said matrix.

5. The construction of claim 4 wherein individual ones of said fibers extend the full length of said regions to which said overlay is applied.

6. The construction of claim 5 wherein said matrix comprises a resin.

7. The construction of claim 5 wherein said overlay is preformed to a predetermined size and shape separately from said metal sheet chassis member and thereafter bonded to said regions.

8. The construction of claim 1 wherein said chassis member has opposite surfaces and where said overlay is applied it is applied to only one of said surfaces.

9. The construction of claim 1 wherein said chassis member comprises at least a portion of a vehicle frame.

10. A method of fabricating a vehicle chassis, comprising:
forming a shaped metal sheet chassis member having predetermined regions with relatively lower torsional rigidity than other regions of the chassis member; and
applying a composite overlay to at least some of the low torsional rigidity regions in the form of directionally oriented fibers embedded in a resin matrix and thereby increasing the torsion rigidity of such regions.

11. The method of claim 9 wherein the torsional rigidity of the chassis member is increased at a rate of less than 10 kg/Hz.

12. The method of claim 10 wherein the increase in torsional rigidity is at a rate of about 4.5 kg/Hz.

13. The method of claim 9 wherein the overlay is formed and shaped separately from the chassis member and thereafter bonded to the chassis member.

14. The method of claim 9 wherein the overlay is applied and formed to shape in place on the chassis member.

15. The method of claim 9 wherein the chassis member is formed as at least a portion of a vehicle frame.
